(19) United States
(12) Patent Application Publication
(10) Pub. No.: US 2022/0215155 A1
(43) Pub. Date: Jul. 7, 2022

(54) DATA LINKING WITH VISUAL INFORMATION

(71) Applicant: International Business Machines Corporation, Armonk, NY (US)

(72) Inventors: Pathirage Dinindu Sujan Udayanga Perera, San Jose, CA (US); Cartic Ramakrishnan, Campbell, CA (US); Sheng Hua Bao, San Jose, CA (US)

(21) Appl. No.: 17/140,290

(22) Filed: Jan. 4, 2021

(51) Int. Cl. G06F 40/12; G06F 40/40; G06F 40/284; G06K 9/00

(52) U.S. Cl. CPC G06F 40/12; G06F 40/40; G06K 2209/01; G06K 9/00442; G06F 40/284

(57) ABSTRACT

Provided are embodiments for performing data linking with visual information. Embodiments include receiving a form including at least one or more entities, determining a visual location information of the at least one or more entities in the forms, and identifying one or more attributes in the form. Embodiments also include linking the at least one entity with one or more attributes using the visual location information of the at least one entity, and providing structured data linking the at least one entity with the one or more attributes.

### BACKGROUND

The present invention generally relates to improved data processing technology, and more specifically, to data linking with visual information.

With the increased usage of computing systems and networks, users are currently inundated and overwhelmed with the amount of information that is made available to them from various structured and unstructured sources. However, information gaps abound as users try to piece together portions of information deemed to be relevant during searches for information on various subjects. The information can be organized in any number of ways. Various techniques can be used to process the vast amount of information that has been received from the different sources to extract the desired information.

### SUMMARY

Embodiments of the present invention are directed to a computer-implemented method for performing data linking with visual information is shown. A non-limiting example of the computer-implemented method includes receiving a form including at least one or more entities, determining a visual location information of the at least one or more entities in the forms, and identifying one or more attributes in the form. The computer-implemented method also includes linking the at least one entity with one or more attributes using the visual location information of the at least one entity, and providing structured data linking the at least one entity with the one or more attributes. Also embodiments of the present invention are directed to a system and a computer program product for performing data linking with visual information.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for performing data linking using visual information in accordance with one or more embodiments of the invention;

FIG. 2 depicts an abstract representation of a form used for data linking with visual information in accordance with one or more embodiments of the invention;

FIG. 3 depicts an abstract representation of another form used for data linking with visual information in accordance with one or more embodiments of the invention;

FIG. 4 depicts a flowchart of a method for performing data linking in accordance with one or more embodiments of the invention; and

FIG. 5 depicts a system for practicing the teachings provided herein.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number correspond to the figure in which its element is first illustrated.

### DETAILED DESCRIPTION

One or more embodiments of the present invention provide techniques to use visual co-location of entities within a form to determine relationships between the concepts. Forms, digital forms, and paper forms are used to collect information for limitless applications. For example, forms are used for patients attending a doctor's appointment, applying for college, requesting a credit card, etc. Currently, there is no universal form that is sufficient to meet the needs of all applications due to the different types of information that is collected.

In the medical field, patients and medical practitioners regularly use different types of forms to maintain information about treatments, procedures, and other information. Oftentimes, the different types of forms may contain the same information or overlapping information that may be organized differently. For example, forms generally include information such as the patient's name, date-of-birth, address information, etc. This information may be located on different portions of the forms. Therefore, it may be challenging to locate the same information in multiple forms.

Also, in the medical field, for example, the forms may include information associated with the drugs the patient is currently prescribed. In a single form, there may exist multiple drugs that a patient may be prescribed. For example, drug A and drug B may be provided in the form where each of the drugs may be associated with a respective dosage. Existing technologies may face challenges when extracting the drugs and their corresponding dosage information using the current text processing techniques because they are limited to simply identifying whether the entity type is present within the form. Therefore, the current systems are unable to form the link or associations between the multiple drugs and corresponding dosage when provided in a single form.

One or more embodiments of the present invention provide technological improvements over current techniques for processing the texts of various types of forms. Disadvantages of contemporary approaches may be limited to simply identifying whether an entity exists within a form. In addition, further limitations may exist when an entity includes a plurality of corresponding attributes. It may prove challenging to link the appropriate attributes with the corresponding entities. One or more embodiments of the present invention provide technical solutions to one or more of these disadvantages of existing solutions by providing a mechanism to identify and link the entities and the corresponding attributes using a visual representation of the data on a form.

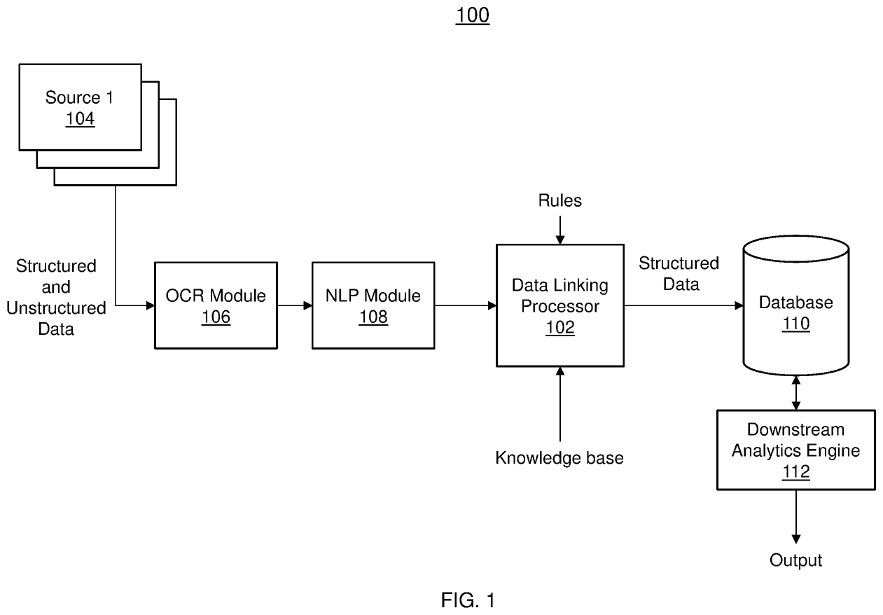

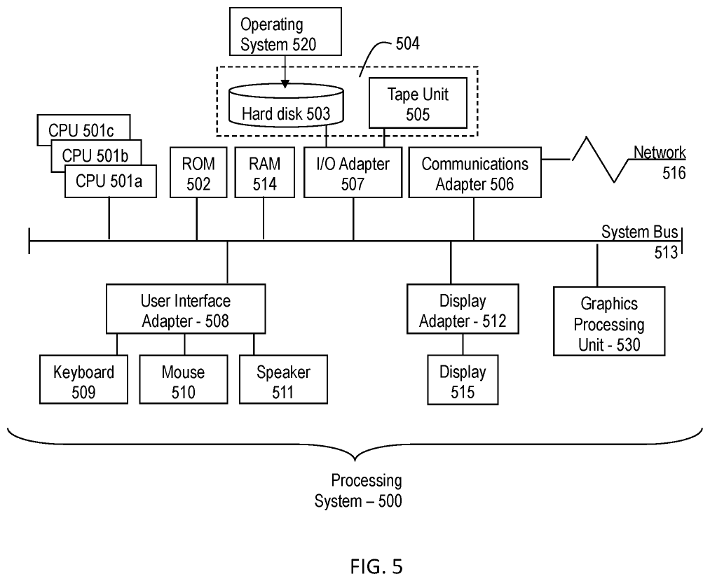

Turning now to FIG. 1, a block diagram of a system 100 for performing data linking is generally shown in accordance with one or more embodiments of the invention. The system 100 includes a data linking processor 102 as shown in FIG. 1. The data linking processor 102 can be incorporated in one or more elements as shown in the system 500 of FIG. 5 to perform the data linking using visual information according to one or more embodiments of the invention. Although the elements of the system 100 are shown as separate elements, it should be understood that the elements can be integrated into a single processing unit or a combination of separate elements and a combination of elements. In addition, the data linking processor 102 can be implemented in software and/or hardware or a combination thereof. The data linking processor 102 can receive a plurality of inputs from one or more sources 104. For example, the data linking processor 102 can receive an input for one or more forms, a knowledge-base server, rules (from an administrator or external source), etc.

The system 100 can include an Optical Character Recognition (OCR) module 106. OCR is the mechanical or electronic conversion of scanned images of handwritten, typewritten, or printed text into machine-encoded text. OCR is widely used as a form of data entry from some sort of original paper data source, whether documents, sales receipts, mail, or any number of printed records. OCR is a common method of digitizing printed texts so that they can be electronically searched, stored more compactly, displayed on-line, and used in machine processes such as machine translation, text-to-speech, and text mining. OCR is a field of research in pattern recognition, artificial intelligence, and computer vision

The OCR module 106 can process the documents and forms that are received from one or more sources 104 providing various types of forms. The forms may be passed to the OCR module 106 which extracts various entities and attributes from the form. As discussed above, the OCR module 106 may extract text, numbers, and symbols from the forms. According to one embodiment, the OCR module 106 may also recognize attribute placement, form fields, white space, separator bars, text groups, columns, color differences, and other features of the forms.

The OCR module 106 identifies the text fields or text boxes that correspond with the entities and attributes of the forms. In one or more embodiments of the invention, centroid based positioning is utilized to abstract out a template of the form which provides an organization of the form. The OCR module 106 can also provide x-y coordinates to the data linking processor 102 to determine the visual location of one or more fields and sections in the form.

According to at least one implementation, the present embodiment of the invention may obtain form understanding automatically by analyzing the texts and images and combining them. The present embodiment may obtain form understanding by utilizing existing technology, such as image processing optical character recognition on form types based on templates. As such, the present embodiment may analyze the form type by analyzing the following elements of the form: headings; text fields and boxes, size and shape of the text fields and boxes, such as the height and length of the fields and boxes; labels; data values; lines or axes; headers or footers; etc.

In one or more embodiments of the invention, the boxes for the entities and attributes may contain a single term or a narrative including a plurality of terms. In such an event, the text will be provided to a natural language processing (NLP) module 108 for analysis. Implementations of the present embodiment may also utilize existing technology such as information retrieval using NLP to analyze, interpret the text provided in the one or more forms. NLP is a field of computer science, artificial intelligence, and linguistics that implements computer processes to facilitate interactions between computer systems and human (natural) languages. NLP enables computers to derive computer-understandable meaning from natural language input. The International Organization for Standardization (ISO) publishes standards for NLP, one such standard is ISO/TC37/SC4. Semantic analysis is the implementation of computer processes to generate computer-understandable representations of natural language expressions. Semantic analysis can be used to construct meaning representations, semantic underspecification, anaphora resolution, presupposition projection, and quantifier scope resolution, which are known in the art. Semantic analysis is frequently used with NLP to derive computer-understandable meaning from natural language input. An unstructured information management architecture (UIMA), which is an industry-standard for content analytics, may be used by the data linking processor 102 to implement NLP and semantic analysis.

In one or more embodiments of the invention, a knowledge-base, from a server or processor, is provided as an input to the data linking processor 102. The knowledge-base is developed by domain experts and defines the relationships between the entities/entity type and their corresponding attributes. By using the knowledge-base, the entities may be associated with the expected attributes determined by the knowledge-base. For example, if the entity is a drug, it would be expected the drug would have attributes such as a dose, a start date, an end date, etc. that are associated with the drug.

In one or more embodiments of the invention, rules can be provided to and received at the data linking processor 102. The rules are not unique to a single type of form but are generally universal to all forms that may be processed by the system 100. For example, a rule will show that typically the start date occurs before the end date and therefore, will if two dates are obtained. The first date will be associated with the start date and the end date with the latter.

Also, rules can determine how blank fields can be analyzed in the context of the form. For example, if an attribute corresponding to an End Date is left blank the system 100 will be able to manage blank entity and/or attribute field without providing an error. The data linking processor 102 is configured to co-locate the entities and attributes to determine the association between the extracted terms using the location information of the entities/attributes, the domain knowledge-base, and the rules that are applied to the forms.

Various forms providing the same information can be provided in different ways. Each of the forms typically have the same information but may be organized in a different manner. By processing the different forms using the techniques described herein, the extract data can be structured in a manner that facilitates analytics. In one or more embodiments of the invention, an output of the data linking processor 102 provides the structured data extracted from the one or more forms to the database 110. This enables analytics to be efficiently performed on the structured data obtained from the various forms.

By structuring the data in a database 110, downstream analytics engines 112 and applications can perform various analytics and provide responses to a broad range of queries. For example, the information for a particular patient can be aggregated across various form types and provided for the users. For example, the downstream application may be able to obtain all of the drugs, doses, duration of time to use the drug, etc. from the various forms.

The database 110 may be queried by a downstream process to obtain various information. For example, in a medical environment, practitioners may be able to obtain drug/dose information for a particular patient. In another example, the practitioner may obtain aggregated information for a particular drug(s) for a plurality of patients. It should be understood the examples are only illustrative and not intended to limit the scope of the data linking techniques described herein.

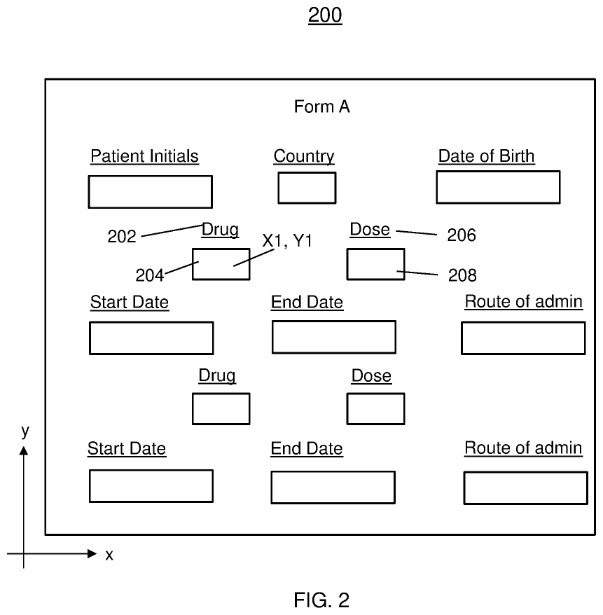

FIG. 2 depicts an abstract representation of a form A (200) having a plurality of fields representing entities and attributes for a medical patient. In this non-limiting example, the entities can include Patient Initials, Country, Date of Birth, Drug, Dose, etc. The entity 202 for the Drug is labeled for reference. Each of the entities is associated with a field for attribute information to be provided. As illustrated each of the fields for the entities are located on different portions of the form and can also be of varying sizes (height, length). In one or more embodiments of the invention, each form can be represented on an x-y coordinate plane and each entity/entity type and attribute/attribute type can be defined by the x, y coordinates. The visual locations can be defined by x, y coordinates (X1,Y1) and (X2,Y2). In another embodiment, the field 204 may be a centroid identifying the center of the field 204 that is defined by a single x, y coordinate.

In this non-limiting example, the field 204 is an input field that corresponds with the entity 202 representing Drug. In another example, the entities for Patient Initials, Country, Date of Birth have corresponding fields. Each entity, such as the Drug, may have corresponding attributes such as a Dose 206, a Start Date, and an End Date. The Dose 206 is an attribute that has a corresponding text field 208. It should be understood that the entity can be associated with one or more attributes.

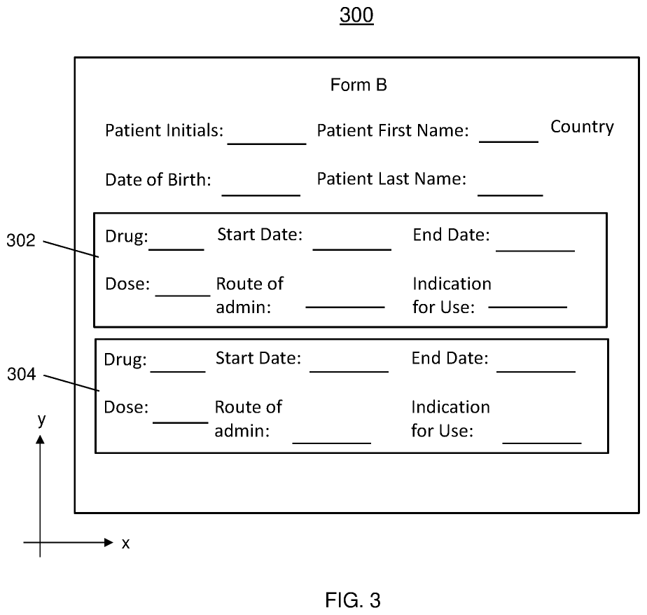

FIG. 3 depicts another representation of a form B (300) having a plurality of entities and corresponding attributes. Although the form 300 includes similar entities as the form 200 shown in FIG. 2, the location of the entities and attributes may be located on different parts of the form 300. In addition, different forms may include different types of information. The form 300 includes entities for the Drugs and further includes attributes such as the Dose, Start Date, End Date, etc. After the location of the entity is found in the form, the form 300 is further analyzed in the direction from left to right (reading direction) to find text that may be associated with the entity. In this example, a first drug and its corresponding attributes are identified as shown in box 302 and a second drug and its corresponding attributes are shown in box 304. By identifying the position of the entities from the unstructured forms the correct attributes can be associated with each entity based on the proximity of information on the form. It is to be understood the representation of the forms provided in FIGS. 2 and 3 is only provided for illustrative purposes and any other type of forms can be received and processed by the system 100 to extract the unstructured entity/attribute information.

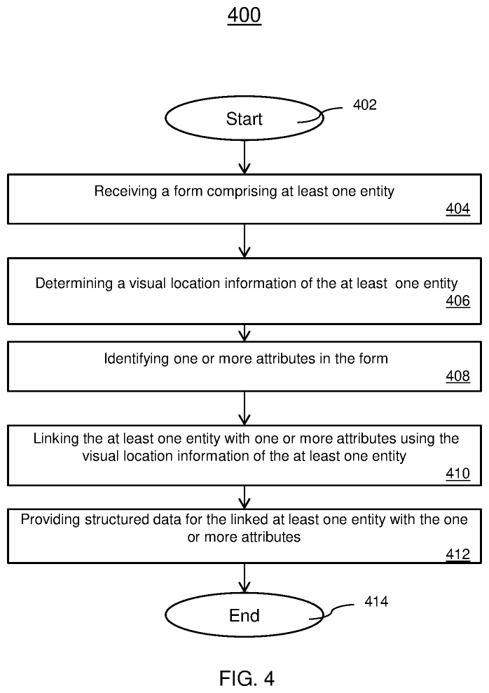

Now referring to FIG. 4, a flowchart of a method 400 for performing data linking in accordance with one or more embodiments of the invention is shown. The method 400 can be implemented in a system such as system 100 shown in FIG. 1. The method 400 begins at block 402 and proceeds to block 404 which provides for receiving a form comprising at least one entity. Block 406 determines visual location information of the at least one entity. The visual location information can include the x, y coordinate that corresponds to a physical location of the entity type within the form and is obtained using OCR techniques.

Block 408 identifies one or more attributes in the form. In one or more embodiments, the data linking processor 102 will process the text of the form starting from the entity and continuing through the text from left to right (reading direction). Block 410 links the at least one entity with one or more attributes using the visual location information of the entities in the form. The data linking processor 102 uses the x, y coordinates of the entity and identifies attributes that may be within proximity to the entity to form the association. With reference to FIGS. 2 and 3, when the data linking processor 102 identifies a first drug and then a second drug, the data linking processor 102 will associate the attributes that physically appear between the first drug and the second drug as belonging to the first drug. The data linking processor 102 will also link the attributes shown after the second drug as belonging to the second drug because of the location of the information in the forms.

The relative position of the information in the forms indicate the entities and attributes that are likely to be associated with each other and should be linked together. The data linking processor 102 can use the knowledge base and rules to make decisions to link the entities/attributes. For example, the knowledge base can provide data indicating what kind of entities should be linked with what relationships (e.g., Drug and Dose with relationship ‘takes’). The data linking processor 102 leverages the position information to make the associations. Block 412 provides the structured data linking the at least one entity with the one or more attributes. The method 400 ends at block 414. It should be understood that the steps shown in FIG. 4 is not intended to limit the scope of the method 400 and different steps or sequence of steps can be used to implement the data linking in accordance with one or more embodiments of the invention.

Now referring to FIG. 5, a block diagram of a system 500 in accordance with one or more embodiments is generally shown. In this embodiment, the system 500 has one or more central processing units (processors) 501a, 501b, 501c, etc. (collectively or generically referred to as processor(s) 501). In one embodiment, each processor 501 may include a reduced instruction set computer (RISC) microprocessor. Processors 501 are coupled to system memory 514 and various other components via a system bus 513. Read only memory (ROM) 502 is coupled to the system bus 513 and may include a basic input/output system (BIOS), which controls certain basic functions of system 500.

FIG. 5 further depicts an input/output (I/O) adapter 507 and a network adapter 506 coupled to the system bus 513. I/O adapter 507 may be a small computer system interface (SCSI) adapter that communicates with a hard disk 503 and/or tape storage drive 505 or any other similar component. I/O adapter 507, hard disk 503, and tape storage device 505 are collectively referred to herein as mass storage 504. Operating system 520 for execution on the processing system 500 may be stored in mass storage 504. A network adapter 506 interconnects bus 513 with an outside network 516 enabling data processing system 500 to communicate with other such systems. A screen (e.g., a display monitor) 515 is connected to system bus 513 by display adaptor 512, which may include a graphics adapter to improve the performance of graphics intensive applications and a video controller. In one embodiment, adapters 507, 506, and 512 may be connected to one or more I/O busses that are connected to system bus 513 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 513 via user interface adapter 508 and display adapter 512. A keyboard 509, mouse 510, and speaker 511 all interconnected to bus 513 via user interface adapter 508, which may include, for example, a Super I/O chip integrating multiple device adapters into a single integrated circuit.

In exemplary embodiments, the processing system 500 includes a graphics processing unit 530. Graphics processing unit 530 is a specialized electronic circuit designed to manipulate and alter memory to accelerate the creation of images in a frame buffer intended for output to a display. In general, graphics processing unit 530 is very efficient at manipulating computer graphics and image processing, and has a highly parallel structure that makes it more effective than general-purpose CPUs for algorithms where processing of large blocks of data is done in parallel.

Thus, as configured in FIG. 5, the system 500 includes processing capability in the form of processors 501, storage capability including system memory 514 and mass storage 504, input means such as keyboard 509 and mouse 510, and output capability including speaker 511 and display 515. In one embodiment, a portion of system memory 514 and mass storage 504 collectively store an operating system to coordinate the functions of the various components shown in FIG. 5.

The techniques described herein improve over the prior art by providing a mechanism to identify entities and their corresponding attributes. In addition, the mechanism establishes a link between the entity and its corresponding attributes provided in a form based on the visual location information. The established links can be stored in a database and enables analytics to be performed on the extracted data.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method for performing data linking with visual information, the computer-implemented method comprising:
receiving, at a data linking processor, a form comprising at least one or more entities, wherein the form is an unstructured form;
performing optical characterization recognition (OCR) process on the form;
determining a visual location information of the at least one or more entities in the form based at least in part on the OCR process;
identifying one or more attributes in the form based at least in part on the OCR process;
performing natural language processing (NLP) to obtain the at least one entity and the one or more attributes that appear in narrative form, wherein if the at least one entity or the one or more attributes are blank, no error is provided;
linking the at least one entity with one or more attributes using the visual location information of the at least one entity; and
providing structured data linking the at least one entity with the one or more attributes.

2. The computer-implemented method of claim 1, wherein the visual location information is an x-y coordinate of the form.

3. The computer-implemented method of claim 2, wherein the x-y coordinate of the form corresponds to a text box.

4. The computer-implemented method of claim 1, wherein the at least one entity comprises a plurality of attributes.

5. (canceled)

6. The computer-implemented method of claim 1, further comprising performing the linking is further based at least in part on receiving a domain knowledge-base associated with the at least one entity and the one or more attributes.

7. The computer-implemented method of claim 1, further comprising performing the linking is further based at least in part on one or more rules associated with the at least one entity and the one or more attributes.

8. A system for implementing data linking using visual information, the system comprising:
a memory coupled to a processor, wherein the processor is configured to:
receive a form comprising at least one or more entities, wherein the form is an unstructured form;
perform optical characterization recognition (OCR) process on the form;
determine a visual location information of the at least one or more entities in the form based at least in part on the OCR process;
identify one or more attributes in the form based at least in part on the OCR process;
perform natural language processing (NLP) to obtain the at least one entity and the one or more attributes that appear in narrative form, wherein if the at least one entity or the one or more attributes are blank, no error is provided;
link the at least one entity with one or more attributes using the visual location information of the at least one entity; and
provide structured data linking the at least one entity with the one or more attributes.

9. The system of claim 8, wherein the visual location information is an x-y coordinate of the form.

10. The system of claim 9, wherein the x-y coordinate of the form corresponds to a text box.

11. The system of claim 8, wherein the at least one entity comprises a plurality of attributes.

12. (canceled)

13. The system of claim 8, further comprising performing the linking is further based at least in part on receiving a domain knowledge-base associated with the at least one entity and the one or more attributes.

14. The system of claim 8, further comprising performing the linking is further based at least in part on applying one or more rules to the at least one entity and the one or more attributes.

15. A computer program product for performing data linking using visual information, the computer program product comprising:
a computer-readable storage medium having stored thereon first program instructions executable by a processor to cause the processor to:
receive a form comprising at least one or more entities, wherein the form is an unstructured form;
perform optical characterization recognition (OCR) process on the form;
determine a visual location information of the at least one or more entities in the form based at least in part on the OCR process;
identify one or more attributes in the form based at least in part on the OCR process;
perform natural language processing (NLP) to obtain the at least one entity and the one or more attributes that appear in narrative form, wherein if the at least one entity or the one or more attributes are blank, no error is provided;
link the at least one entity with one or more attributes using the visual location information of the at least one entity; and
provide structured data linking the at least one entity with the one or more attributes.

16. The computer program product of claim 15, wherein the visual location information is an x-y coordinate of the form.

17. The computer program product of claim 16, wherein the x-y coordinate of the form corresponds to a text box.

18. The computer program product of claim 15, wherein the at least one entity comprises a plurality of attributes.

19. (canceled)

20. The computer program product of claim 15, wherein the instructions are further executable by a processor to cause the processor to perform the linking based at least in part on receiving a domain knowledge-base associated with the at least one entity and the one or more attributes, and based at least in part on applying one or more rules to the at least one entity and the one or more attributes.
